(19) United States
(12) Patent Application Publication
(10) Pub. No.: US 2016/0009046 A1
(43) Pub. Date: Jan. 14, 2016

(54) FORMWORK OR CONSTRUCTION ELEMENT AND A NEW MATERIAL

(71) Applicant: Consystex Pty Ltd, Sydney (AU)

(72) Inventor: Mariano VILLAESCUSA, Sydney (AU)

(73) Assignee: Consystex Pty Ltd, Sydney (AU)

(21) Appl. No.: 14/442,712

(22) PCT Filed: Nov. 13, 2013
(86) PCT No.: PCT/AU2013/001306

§ 371 Date: May 13, 2015

(30) Foreign Application Priority Data
Nov. 13, 2012 (AU) 2012905000

(51) Int. Cl. B32B 1/08; B32B 5/26; E04G 13/02; B32B 7/12; B32B 27/12; B32B 29/02; B32B 5/02; B32B 7/04

(52) U.S. Cl. CPC B32B 1/08; B32B 5/022; B32B 5/26; B32B 7/04; B32B 7/12; B32B 27/12; B32B 29/02; E04G 13/021; B32B 2307/7265; B32B 2307/73; B32B 2307/718; B32B 2597/00

(57) ABSTRACT

A formwork or construction element tube 1111, which is made from multiple layers of a multi-layered material 100, 200, 10, which includes at least two filament reinforcing layers. There can also be included at least one layer of paper, cardboard or polymer, the layers being bonded together. The present invention also provides a multi-layered material, which has a base layer of a filament layer 20 and a backing layer 15 or 25 to form a sheet material 10, 100, 200, which includes at least one non-woven filament strength or reinforcing layer, and a layer of paper, cardboard or polymer, the layers being bonded together.

### FIELD OF THE INVENTION

The present invention relates to a material, more particularly to a multi-layered material suitable for making sheet products which can have a variety of uses, including being formed into tubing used in a range of applications including forming concrete columns. The present invention also relates to a formwork or construction made from such a material, for use as a building or construction element or in forming a building element such as a column or pier. The formwork or construction element can be wound by known techniques such as spiral winding or other winding techniques.

### BACKGROUND OF THE INVENTION

Multi-layered materials such as multi-layered paper constructions have been used to manufacture construction products, such as the paper tubing used for forming concrete columns. A potential problem involved in using paper tubing for forming concrete columns involve, for example, a weakening of the paper tubing as the paper or cardboard material becomes wetted. It is also desirable to increase the tensile strength and burst pressure of the tubing.

Any reference herein to known prior art does not, unless the contrary indication appears, constitute an admission that such prior art is commonly known by those skilled in the art to which the invention relates, at the priority date of this application.

### SUMMARY OF THE INVENTION

The present invention provides a formwork or construction element tube having multiple layers which include at least two layers comprised of a multi-layered sheet material, each of said multi-layered sheet material including at least one non-woven filament layer that includes a plurality of reinforcing filaments, each of said multi-layered sheet material also including said non-woven filament layer being bonded or adhered to at least one layer of paper, cardboard or polymer.

The multiple layers can also include at least one layer of paper, cardboard or polymer between said at least two multi-layered sheet materials.

The multi-layered sheet material can each have a multiple number of non-woven filament layers.

The tube can be formed by one or more than one of the following means: an adhesive is used to bond said multiple layers together into said tube; a heat bonding process is used to bond said multiple layers together into said tube; said multiple layers are spirally wound; said multiple layers are cylindrically or straight wound; said multiple layers are wrapped.

There can be at least three layers of said multi-layered sheet material, and at a location intermediate an inner and outer layer of said multi-layered sheet material is located said at least one layer of paper, cardboard or polymer, each layer being bonded by an adhesive layer or other means.

The tube can include at least one layer which is a hydrophobic layer or a waterproofing layer. The at least one layer of said hydrophobic layer or a waterproofing layer can be located at one or more than one of the following: an innermost layer of said tube, an outermost layer of said tube; an intermediate layer of said tube.

The filaments can extend in one of the following directions: in the general longitudinal direction of said multi-layered sheet material; at an angle to the general longitudinal direction of said multi-layered sheet material; if more than one then a first in the general longitudinal direction and another at an angle in the range of 5 to 90 degrees to the general longitudinal direction of said multi-layered sheet material.

The filaments can be one or more of the following: strips; ribbons, straps; strands; tapes; said filaments are spaced from each other in said non-woven filament layer; polymeric; fibreglass; metal wire filaments; polypropylene; polyethylene; a polypropylene and polyethylene blend; polyester; or a blend of polymers.

When assembled in said tube, a first non-woven filament layer can have its directional strength characteristics at an angle to a second non-woven filament layer

The present invention also provides a multi-layered material, including at least one non-woven strength layer, and a layer of paper, cardboard or polymer, the layers being bonded together.

The non-woven strength or reinforcing layer can be a full width strength layer, alternatively it can be a filament layer which includes a plurality of strips, tapes, strands, or straps, in the form of filaments.

The filament layer can include filament which run in a longitudinal direction of the multi-layered material, or in a direction that is at about a 5 to 90 degree angle to the longitudinal direction.

The non-woven strength layer can be a combination of full width and filament layers.

The multi-layered material can include at least two non-woven strength layers being: (a) a full width strength layer and a layer of filaments, (b) two full width strength layers, or (c) two layers of filaments.

The layer of filaments can include a plurality of strips, straps, strands, or tapes of filaments, the strips or tapes being spaced from each other.

Multiple layers of filaments can be present in the strength layers, wherein the adjacent layers can overlap or overlie each other.

The strips or tapes of filaments from one non-woven strength layer can overlie spacing between filament strips or tapes of the other non-woven strength layer.

Filaments in the non-woven strength layer can be polymeric, fibreglass, or metal wire filaments, or a combination of these.

When the filaments are of a polymeric material, the material can be polypropylene, polyethylene, a polypropylene and polyethylene blend, or polyester.

The layer of paper, cardboard or polymer can be paper, and can weigh 20 grams per square meter or more.

The multi-layered material can further include a coating on either or both of the non-woven strength layer and layer of paper, cardboard or polymer.

The coating can be food grade.

The multi-layered material can further include another paper layer that is bonded to the layer of paper, cardboard or polymer, the layer or paper, cardboard or polymer and the other paper layer being bonded together by a waterproof adhesive film.

The waterproof adhesive film can be food grade.

The multi-layered material can further include two or more non-woven strength layers, there being at least one layer of paper, cardboard, or polymer, or a coating layer, between each adjacent two of the two or more non-woven strength layers.

The filaments can be multi-strand filaments.

The filaments can run in a roll direction of the multi-layered material.

The multi-layered material can further include an adhesive film as an outer layer.

One or both outer layers can be paper, or polymeric material.

A second non woven strength layer can be adhered or bonded so that a directional strength characteristic of the second non-woven strength layer is at an angle to a directional strength characteristic of a first non-woven strength layer.

The second non woven strength layer can be a filament layer and this can be at an angle to a first filament layer.

A layer of cardboard, paper or polymer can be between said first and second layer.

The first layer can be located between a layer of cardboard, paper or polymer and second layer.

The second layer can have its directional strength characteristics at an angle of between 5 and 90 degrees to said first layer.

The multi-layer material described above can be such that a first of said non woven strength layers is arranged in said material so that a directional strength characteristic of said first layer, is parallel to the roll or machine or longitudinal direction of said material, and said second layer has its directional strength characteristic is at an angle thereto, and that angle can be in the range of 0 to 90 degrees.

The multi-layer material described above can be such that there is only one non woven strength layer and that layer has a directional strength characteristic, or filaments or straps thereof, which is or are aligned in a manner which is one of the following: generally parallel to the roll or machine or longitudinal direction of said material; generally lateral to the roll or machine or longitudinal direction of said material, i.e. a cross direction; at an angle other that of parallel to or at 90 degrees to the roll or machine or longitudinal direction of said material.

The present invention also provides a tube formed from spiral winding a multi-layered material as described in the paragraphs above.

### BRIEF DESCRIPTION OF THE DRAWINGS

An embodiment or embodiments of the present invention will now be described, by way of example only, with reference to the accompanying drawings, in which:

FIG. 1A is a schematic showing a multi-layered material according to an embodiment of the present invention;

FIG. 1B is a schematic showing a multi-layered material according to another embodiment of the present invention;

FIG. 1C is a schematic cross section through material 10 of FIG. 1 perpendicular to direction D, with filaments extending into the page of the figure;

FIG. 2 is a schematic showing a multi-layered material according to another embodiment of the present invention;

FIG. 3 is a schematic showing a multi-layered material according to a further embodiment of the present invention;

FIG. 4 is a schematic showing a multi-layered material according to a further embodiment of the present invention;

FIG. 5 is a schematic showing a multi-layered material according to a further embodiment of the present invention;

FIG. 6 is a schematic showing a multi-layered material according to a further embodiment of the present invention;

FIG. 7 is a schematic showing a multi-layered material according to a further embodiment of the present invention;

FIG. 8 is a schematic showing a multi-layered material according to a further embodiment of the present invention;

FIG. 9 is a schematic showing a multi-layered material according to a further embodiment of the present invention;

FIG. 10 is a schematic showing a multi-layered material according to a further embodiment of the present invention;

FIG. 11 is a schematic showing a multi-layered material according to a further embodiment of the present invention;

FIG. 12 is a schematic showing a multi-layered material according to a further embodiment of the present invention;

FIG. 13 is a schematic showing a multi-layered material according to a further embodiment of the present invention;

FIG. 14 is a schematic showing a multi-layered material according to a further embodiment of the present invention;

FIG. 15 is a schematic showing a multi-layered material according to a further embodiment of the present invention;

FIG. 16 is a schematic showing a multi-layered material according to a further embodiment of the present invention, showing two non-woven filament reinforcing layers, one having filaments extending in the machine or longitudinal direction, while the other is at an angle of 90 degrees to that layer of filaments;

FIGS. 17 and 18 are schematics each showing two non-woven strength layers comprised of filament tapes, where the filament tapes from the two layers partially overlap;

FIG. 19 is a schematic showing two non-woven strength layers comprised of filament tapes, where the filament tapes from the two layers completely overlap;

FIG. 20 is a schematic showing two non-woven strength layers comprised of filament tapes, where the filament tapes from one layer overlies the spacing between the filament tapes of the other layer;

FIG. 21 is a schematic showing two non-woven strength layers comprised each of filaments or tapes, where the filaments or tapes of the second layer 25 overlie the first layer 20;

FIG. 22 is a perspective drawing depicting an existing spiral winding machine;

FIG. 23 is a schematic view showing a multi-layered material according to a further embodiment of the present invention, showing a single layer of non-woven;

FIG. 24 illustrates a part of a spiral or other wound tube, showing the layers thereof;

FIG. 25 illustrates a schematic of a mandrel and spiral winding of the material layers to form a tube similar to that of FIG. 25;

FIG. 26 illustrates a schematic cross section of a part of a spiral wound tube, showing the layers used in a large diameter tube of the order of 1000 mm to 2400 mm and or long length of tube; and

FIG. 27 illustrates a schematic cross section of a part of a spiral wound tube, showing the layers used in a small diameter tube of the order of 200 mm to 1000 mm and or short length of tube.

### DETAILED DESCRIPTION OF THE EMBODIMENT OR EMBODIMENTS

Multi-layered paper or cardboard materials can be used in the field of construction and manufacturing, for example, to be used as the tubing for forming concrete columns. The multi-layered material can also be used as, for example, carpet underlay or lumber packaging material, concrete lining, protective layers and strengtheners of packaging products.

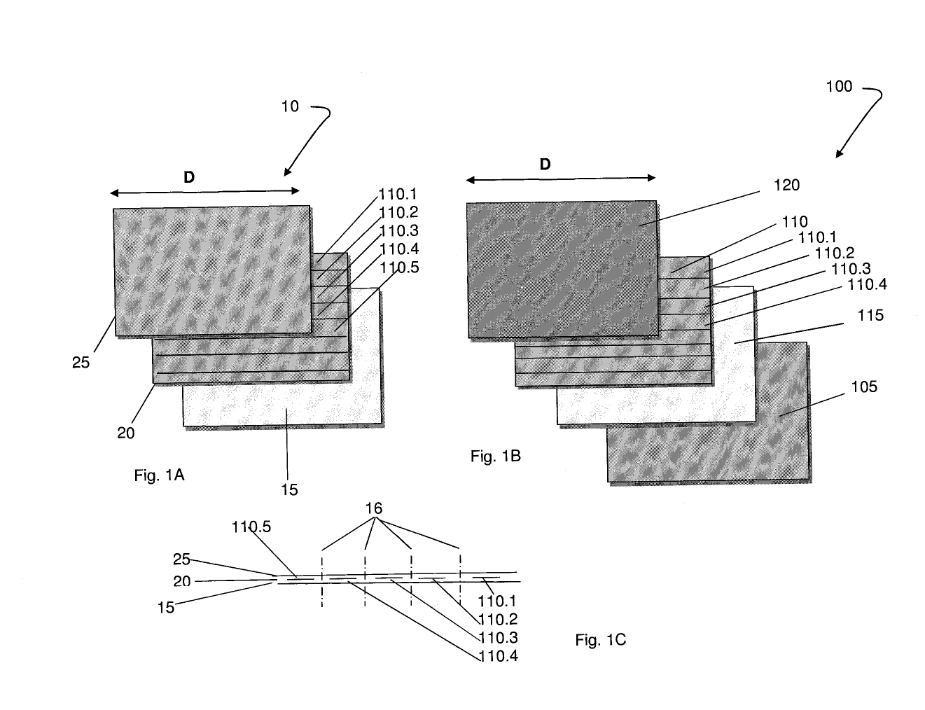

The present technology provides an improved multi-layered construction for the multi-layered material. As shown in FIG. 1A, generally the multi-layered sheet material 10 includes at least a layer of paper, cardboard, or polymeric material 15. For ease of reference, this layer will be referred to as a paper layer, but it should be understood it can be replaced with a cardboard or polymer layer. The paper layer is bonded to a non-woven strength or reinforcing layer 20, which has a layer of filaments, ribbons, strips, straps, strands, or tapes, etc. Additionally there can be one or more other non-woven layers 25, such as a layer of paper, cardboard or polymeric material.

As is described below, further layers can be added to form other variations as depicted in FIGS. 1B and 2 to 16. The non-woven strength or reinforcing filament layer 20 can be made of a filaments, ribbons, strips straps or tapes of a variety of materials, such as polyester, polypropylene, polyethylene, another polymer variant, fibreglass, or a blend of different polymeric or fibreglass materials.

Several embodiments are illustrated in the accompanying drawing figures. The different embodiments can be used for constructing packaging or tubing of different tensile strengths, thicknesses, and weights.

In the embodiments depicted in FIGS. 1B to 15, filament layers are used as the non-woven strength or reinforcing layers. It will be understood that full-width strength or reinforcing layers can be used in place of the filament layers in the following examples.

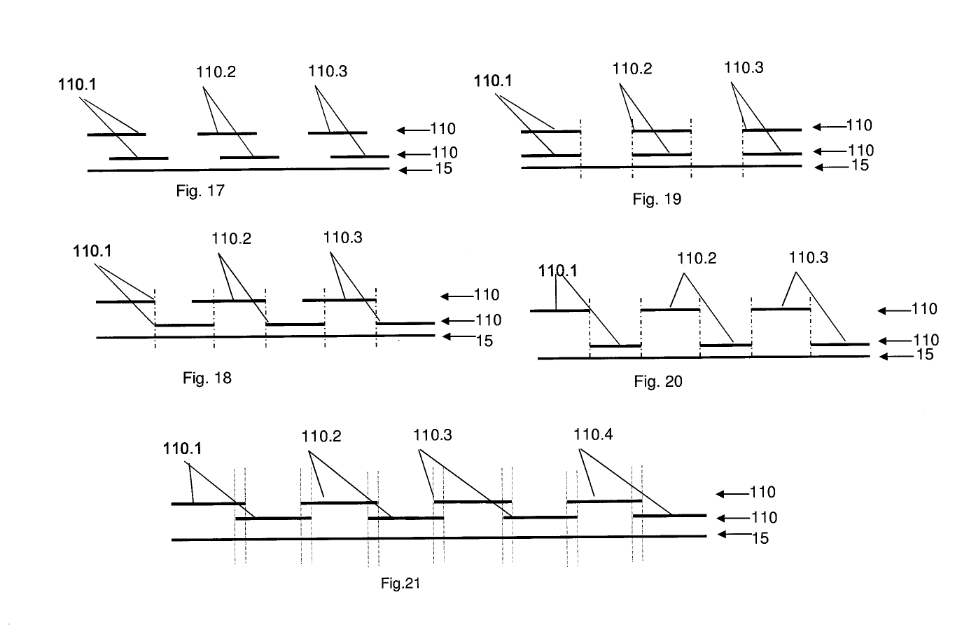

FIG. 1B depicts an embodiment of the multi-layered material. The multi-layered material 100 includes a layer of paper or cardboard 105, and a filament layer 110, with reinforcing filaments 110.1, 110.2, 110.3 and 110.4 identified, with many others being present but not separately identified. In FIG. 1B, the filament layer is illustrated such that the lines of the filaments 110.1, 110.2, 110.3 and 110.4 are represented in the plane of a sheet. This is a schematic representation of the filaments or filament layer. The filaments are applied, adhered or bonded directly to the adjacent polymeric or paper or cardboard layers 120 or 105, or for that matter an intervening strength layer of filaments or a non-woven strength layer, in the manner illustrated in the schematic cross sections of FIGS. 17 to 21.

In FIG. 1B the cardboard layer 105 is made of paper, such as kraft paper, preferably of at least 20 grams per square metre (GSM). The filament layer can be made from filaments or microfilaments of a variety of materials. The filaments or microfilaments can further be multi-strand. Examples of suitable filament materials include polymers such as polyester, polypropylene, polyethylene, or another polymeric variant such as a blended material, or combinations of these different materials.

A specific example of such filaments are those ribbons or flat strands that are made of 100% virgin polypropylene, having a width of approx 2.5 mm and a thickness of approx. 0.02 mm to 0.05 mm, having a fibre tenacity or detex of approx 900 to 1000, a tensile strength of greater than or equal to 45N, an elongation of greater than or equal to 30%, and when wound on a 105 mm bobbin provides a length of approx 12000 m. If desired a thicker filament 110.1 etc. could be used, of the order of 0.05 mm to 0.07 mm or even up to 1 mm and but this may require the use of a thicker coating of adhesive to provide a more rigid product for various applications. However, the preferred thickness for formwork application is of the order of 0.02 mm to 0.05 mm. Thickness of filament can also vary according to the tensile strength characteristic of the material being used.

The filament layer 110 can alternatively be made of fibreglass, wire filaments, or any appropriate metal. The filament material that is chosen is dependent on the requirements for the finished product. In instances where the multi-layered material is to form a roll or tubing, the filaments generally run in the direction of the roll, marked by ‘D’. Also, the filaments can have different cross sections, such as round, oval, or any other appropriate cross section. The resulting roll is preferably presented as having straight edges, without any significant telescoping, creasing, and having no joins.

The filament layer 110 can include high strength filaments arranged in tapes, ribbons, cords, straps, or strands which extend in a longitudinal direction of the material. There can be at least about 5 to 7 tapes or filaments of 2 mm to 2.5 mm width per 25 mm of width of the sheet material. Alternatively, the tapes or filaments can be approximately 1 to 2 mm in width, with 1 to 2 mm spacing between the edges of adjacent tapes or filaments. More preferably, the filaments, ribbons or tapes in the non-woven strength layer 110 are of an average width of 2 mm with 1 mm spacing between adjacent edges.

There can be a layer located between the cardboard layer 105 and the filament layer 110, being a coating or adhesive layer 115 which bonds the two other layers 105, 110 together. The adhesive coating layer 115 can include various resins, such as polymer resins, water or solvent based adhesives which can be heat activated, or heat activated variant polymers, or a resin or adhesive can be used which creates a sealing bond can be used to give the tube a hydrophobic property. As an example, the coating layer 115 which is located between the cardboard layer 105 and the filament layer 110 can be about 30 to 40 μm in thickness. However, in embodiments where the coating layer 115 is not an adhesive layer, the overall layered structure can be produced by being heat bonded, whereby the filament layer 110 has a polypropylene or polyethylene upper and lower layers which sandwich the filament layer.

The filament layer 110 can further have another layer of coating 120, for example about 40 to 45 μm in thickness. The coating layer 120 can be polypropylene, polyethylene, or a polypropylene and polyethylene blend, or another polymer variant. The coating layer 120 can be a coloured coating. Also the coating layer 120 can be hydrophobic or hydrophilic, depending on the application and intended use of the multi-layered material.

As an example, a multi-layered material 100 as discussed above can have a nominal thickness of about 0.30 to 0.40 mm, and a mass of around 235 GSM. Initially, the multi-layered material 100 thus constructed can be formed into widths of approximately 2.4 metres, and formed into another roll, which can be cut or slit and rewound to desired lengths and widths. A preferred roll about 152 to 175 mm in width, and 1000 m or more in length, can be used with existing spiral winding machines, to form a spiral wound tubing of any appropriate internal diameter, for concrete formwork. Typical diameters range between 250 mm and 2000 mm. If a paper layer of about 105 GSM is used, the resulting tubing having two layers of the sheet material 100 and two alternating layers of kraft paper, is expected to have a burst strength in a radial direction of the tubing of about 700 KPa or higher.

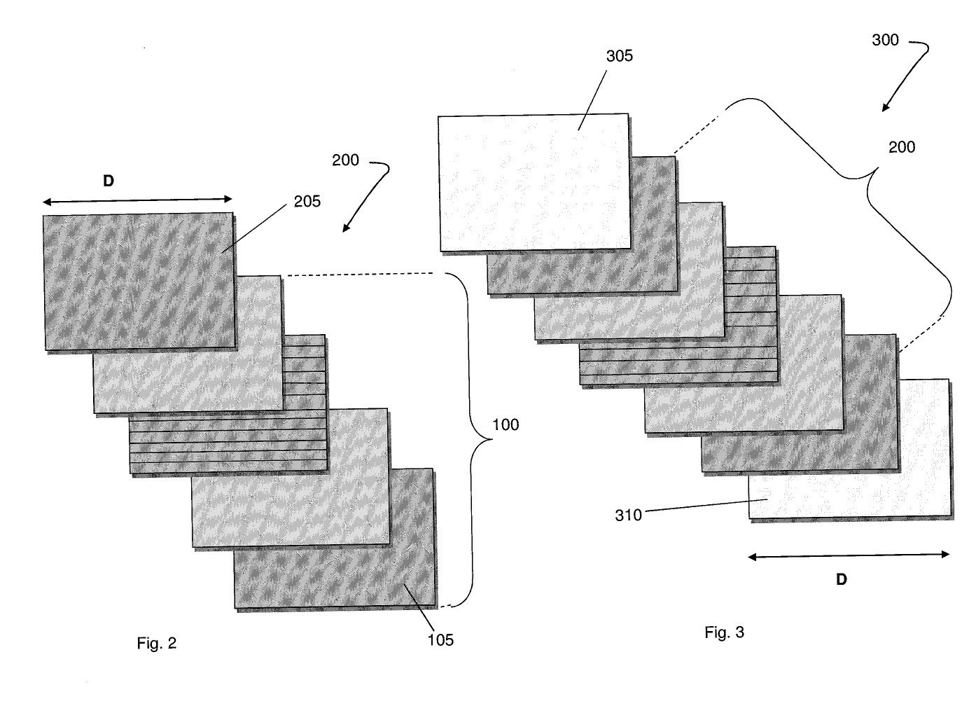

The coating layer 120 can have a bonding function or not. Where it has the same or a similar composition and function as the other coating layer 115, it enables further layers to be bonded to the multi-layered material 100. Therefore, the multi-layered material 100 depicted in FIG. 1B can be considered a base upon from which other embodiments are constructed, or from which variants are made. Exemplary embodiments are shown in FIGS. 2 to 15. Of course, as mentioned above, the layers can be bonded in other ways, such as by roll bonding.

Thus the basic sheet material can be considered to be a filament layer 20 or 110, which is bonded to a paper, cardboard or polymeric layer 15 or 25 in the case of layer 20; or a paper, cardboard or polymeric layer 120 or 105 in the case of layer 110.

As shown in FIG. 2, the multi-layered material 200 includes a further paper or cardboard layer 205 that is bonded to the multi-layered material 100 shown in FIG. 1. The provision of kraft paper layers 205 and 105 on both sides of the overall material 200 increases the strength, thickness, rigidity of the material 200 compared to the embodiment shown in FIG. 1. Tensile and burst pressures of the material 200 are also increased when the material 200 is used as e.g. a construction formwork tube.

As an example, a multi-layered material 200 as depicted in FIG. 2, given kraft paper of about 105 gsm is used, can have a nominal thickness of about 0.45 mm, and a mass of around 340 GSM. The multi-layered material 200 thus constructed can be formed into widths of approximately 2.4 metres, and formed into another roll, which can be cut or slit and rewound to desired lengths and widths. The resulting roll can be about 152 to 175 mm in width, and 1000 m or more in length. The roll can then be spiral wound using existing spiral winding machines into tubing of any appropriate internal diameter, for concrete formwork. The resulting tubing is expected to have a burst strength of 1080 KPa or higher.

FIG. 3 depicts a further embodiment. The multi-layered material 200 is further modified by adding layers of film or polymer blend coating 305, 310, one on either side of the multilayered material 200. The film or polymer blend coating layers 305, 310 can be made water resistant (i.e. hydrophobic), so that the resulting multi-layered material 300 can act as a moisture barrier. The moisture barrier function of multi-layered material 300 can be useful in construction, a metal wrapper application, or in other situations where moisture poses a threat to the finished product.

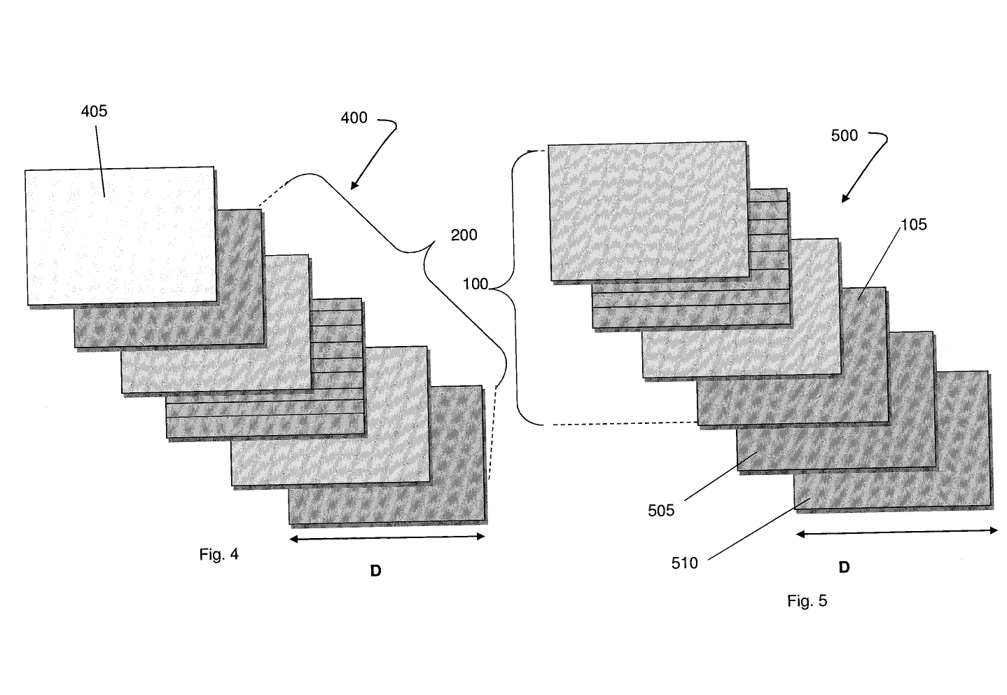

The multi-layered material 400 depicted in FIG. 4 is similar to the multi-layered material 300 depicted in FIG. 3. The difference between the two materials 400, 300 is that the multi-layered material 400 shown in FIG. 4 adds only one film or polymer blend coating layer 405 on one side of the multi-layered material 200 shown in FIG. 2. Other multi-layered materials, or simply another filament layer, can then be bonded to the multi-layered material 400 where further strength and thickness in the overall material is required.

The multi-layered material 500 depicted in FIG. 5 is constructed by adding a waterproof adhesive film 505 which bonds another paper or cardboard layer 510 to the paper or cardboard layer 105 of the basic multi-layered material 100. Another single layer or multi-layered material can be bonded to the paper or cardboard layer 510 to create the desired outcome. The multi-layered material 500 can be used in different applications, e.g. to form spiral wound tubes.

The cardboard, kraft paper, or polymeric layer assist with future bonding of the multi-layered material into spiral wound tubes, by either adhesive or other bonding means.

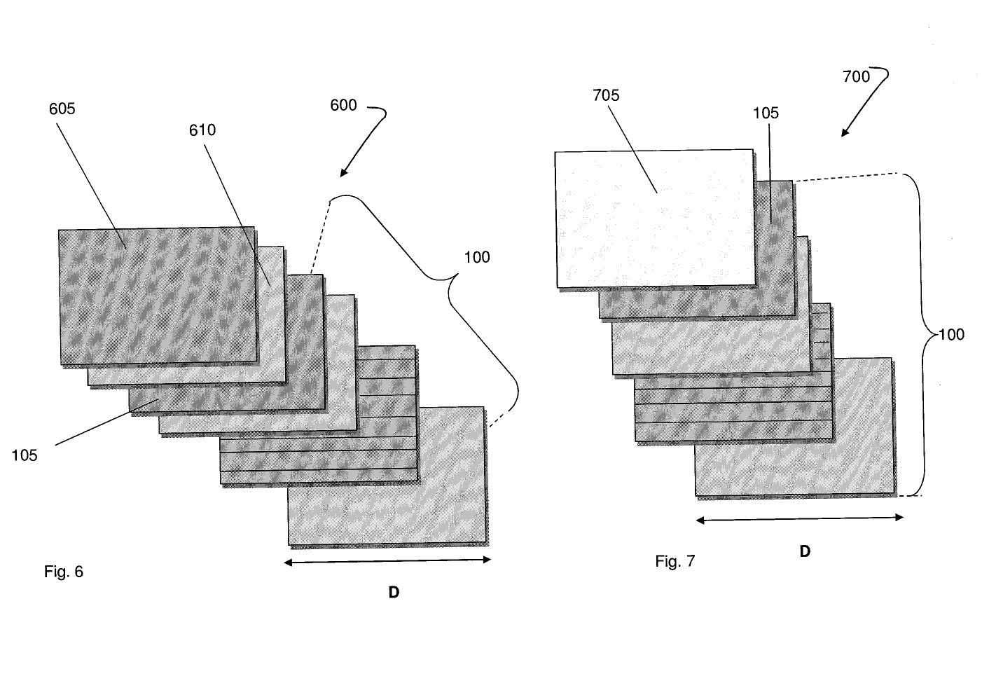

The multi-layered material 600 depicted in FIG. 6 is similar to the multi-layered material 500 depicted in FIG. 5. The difference is that the second paper or cardboard layer 605 is bonded to the paper layer 105 of the basic multi-layered material 100 via a coating layer 610. The coating layer can be the same as or similar to the coating layer 120 used in the multi-layered material 100 shown in FIG. 1, but will have adhesive, resin, or a solvent, etc., to enable the bonding between the paper layers 605, 105.

The multi-layered material 700 depicted in FIG. 7 adds a film or polymer blend coating to the paper layer 705 of the multi-layered material 100 shown in FIG. 1. Further layers or variants of the multi-layered material can be added if desired.

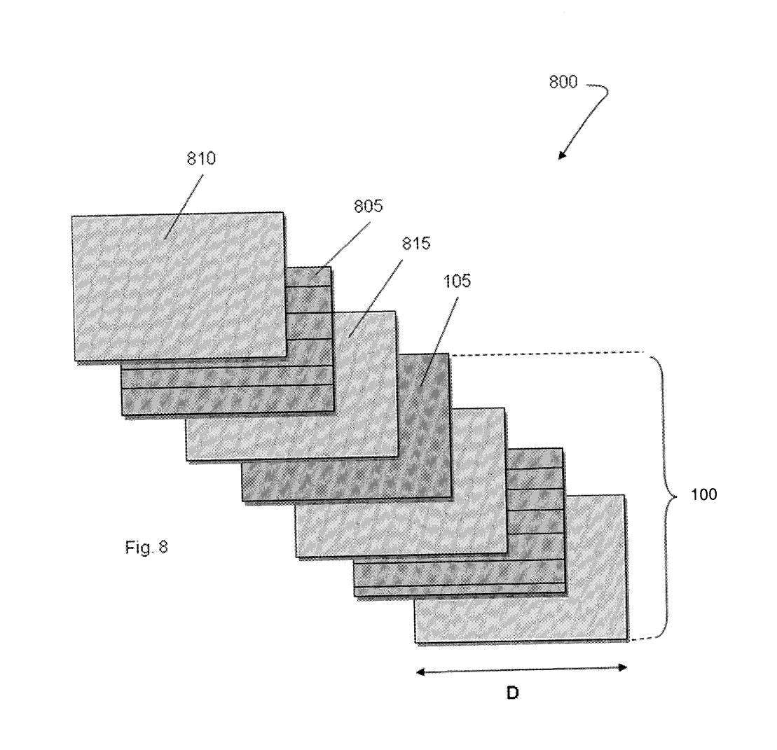

The multi-layered material 800 depicted in FIG. 8 adds a further filament layer 805 sandwiched between two coating layers 810, 815, to the paper layer 105 of the multi-layered material 100 shown in FIG. 1. Again the coating layer 815 closest to the paper layer 105 needs to be able to bond to the paper layer 105.

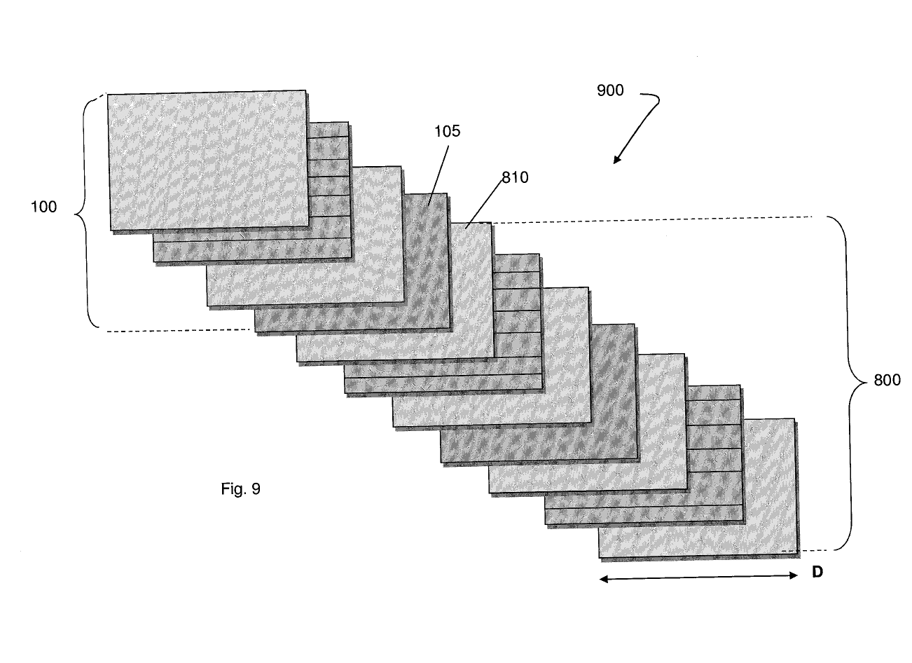

The multi-layered material 900 depicted in FIG. 9 combines the material 100 shown in FIG. 1 to the material 800 depicted in FIG. 8.

The multi-layered materials 800, 900 depicted in FIGS. 8 and 9 have two and three filament layers, respectively. This increases the tensile and burst pressures of the materials 800, 900. The materials 800, 900 are suitable as moisture barrier, heavy duty construction liner, heavy machinery wrap, or metal packaging. The heavier duty material 900 is further suitable for use in the manufacturing of bulk haulage bins.

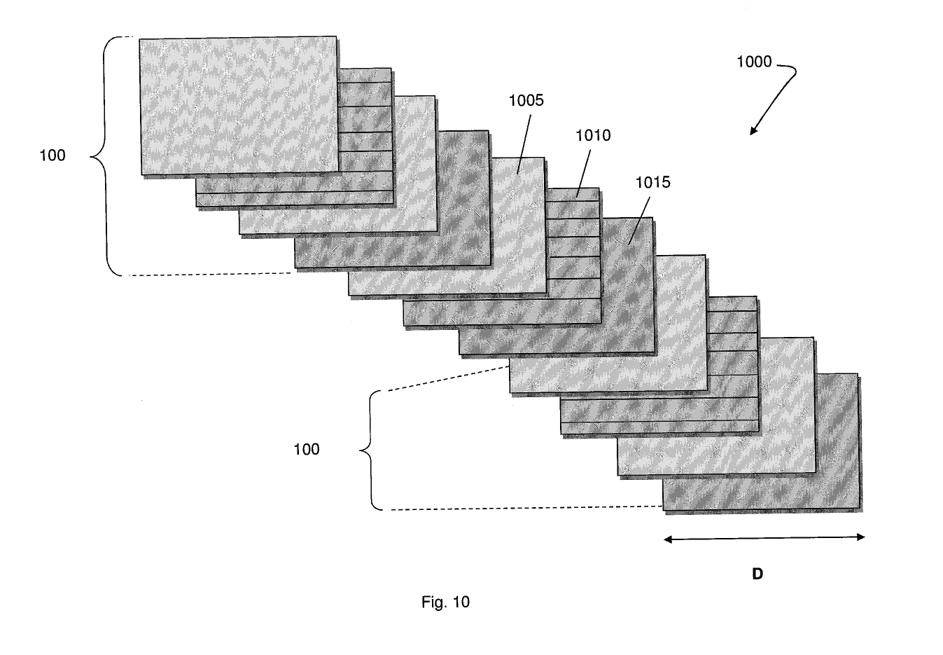

The multi-layered material 1000 depicted in FIG. 10 combines two of the multi-layered materials 100 shown in FIG. 1, one on either side of three centre layers. The three centre layers include a coating layer 1005, a filament layer 1010, and another paper layer 1015. This variant can further be bonded to another variant combination, as it has a kraft paper as an outer layer. Doing so can substantially increase the overall tensile strength, burst pressure, and rigidity in the finished product.

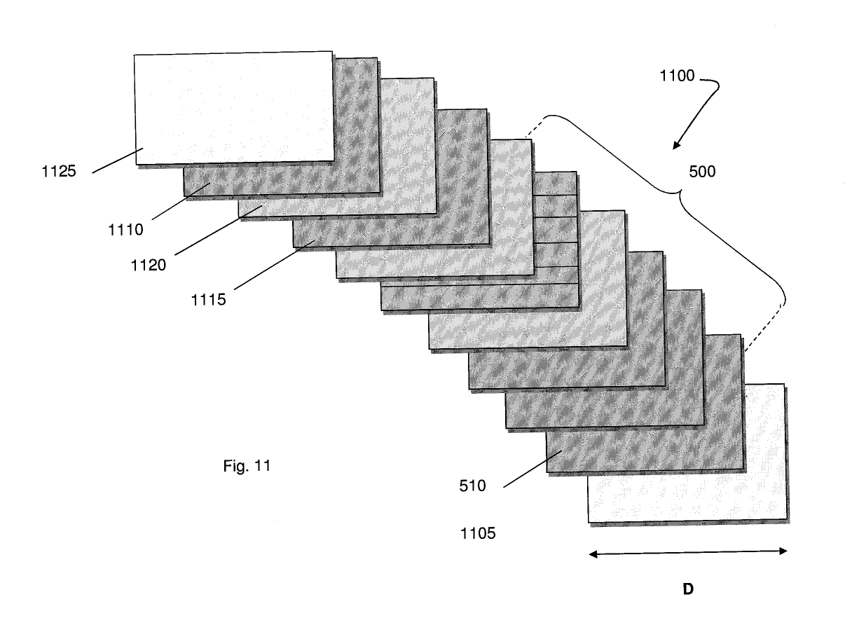

The multi-layered material 1100 depicted in FIG. 11 can be considered as being modified from the multi-layered material 500 shown in FIG. 5. A film or polymer blend coating 1105 is added to the end paper layer 510 of the multi-layered material 500. On the other side of the multi-layered material 500, two paper layers 1110, 1115 which are bonded by a coating layer 1120 capable of bonding the two paper layers 1110, 1115, are added. The outermost of the two paper layers 1110 is further coated with a film or polymer blend coating 1125. This variant 1100 in effect adds two more layers of kraft paper to the embodiment shown in FIG. 5. Due to the presence of multiple layers of paper, coating, and film, this material 1100 can be used in applications where more rigidity and higher strength is required. For example it can be used as a moisture barrier for various commercial, construction, and industrial applications.

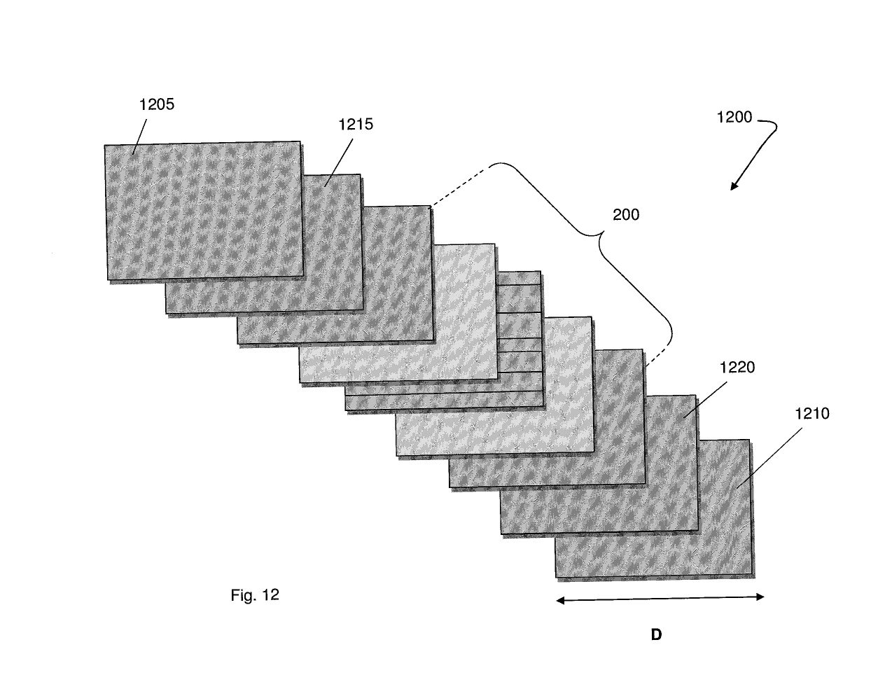

The multi-layered material 1200 depicted in FIG. 12 can be considered as having been modified from the material 200 depicted in FIG. 2. Here, two more paper layers 1205, 1210 are added to the basic material 200, one on each side. The paper layers 1205, 1210 are bonded to the basic material via waterproof adhesive films 1215, 1220, respectively. Both of the outer layers 1205, 1210 of this variant of the multi-layered material 1200 are paper. Therefore if desired two other variants can be further added to this material 1200, one on each side, by the user.

The multi-layered material 1300 depicted in FIG. 13 is a variant of the material 100 depicted in FIG. 1, but still has the basic combination of a paper or polymer layer and a filament layer. Here, a paper layer 1305 is located adjacent a filament layer 1310. A waterproof adhesive film 1315 is added as an outer layer to the paper layer 1305. A coating layer 1320 is added as an outer layer adjacent the filament layer 1310. The positions of the adhesive film 1315 and the coating layer 1320 can be reversed. The adhesive film 1315 allows this variant 1300 to be easily added to another multi-layered material, for applications such as packaging, liner, or wrapping.

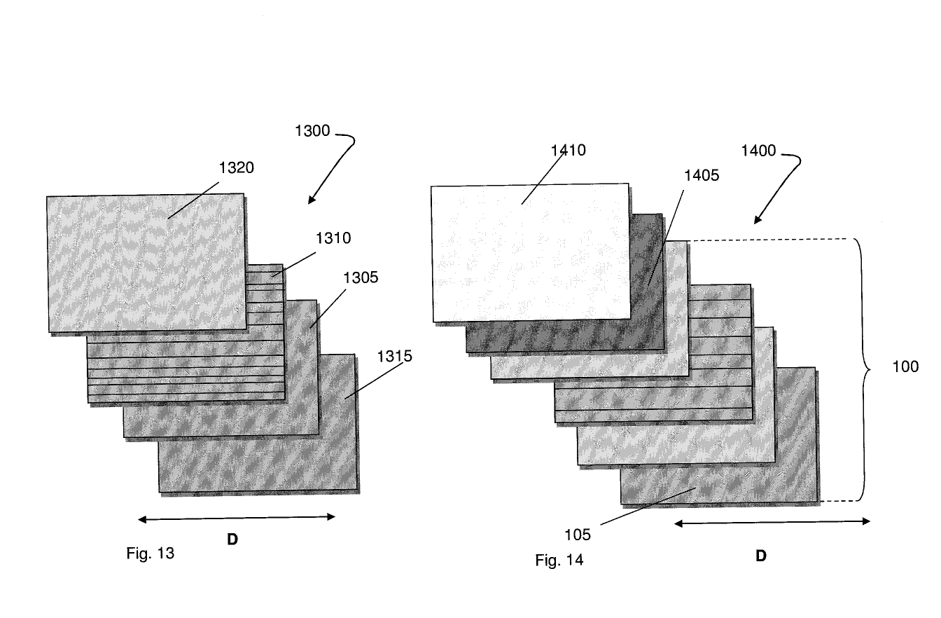

The multi-layered material 1400 depicted in FIG. 14 is another variant of the material 100 depicted in FIG. 1. An aluminium film or sheet 1405 is bonded to the coating layer 120 of the material 100 depicted in FIG. 1. A polymer blend film 1410 coats the aluminium film or sheet 1405.

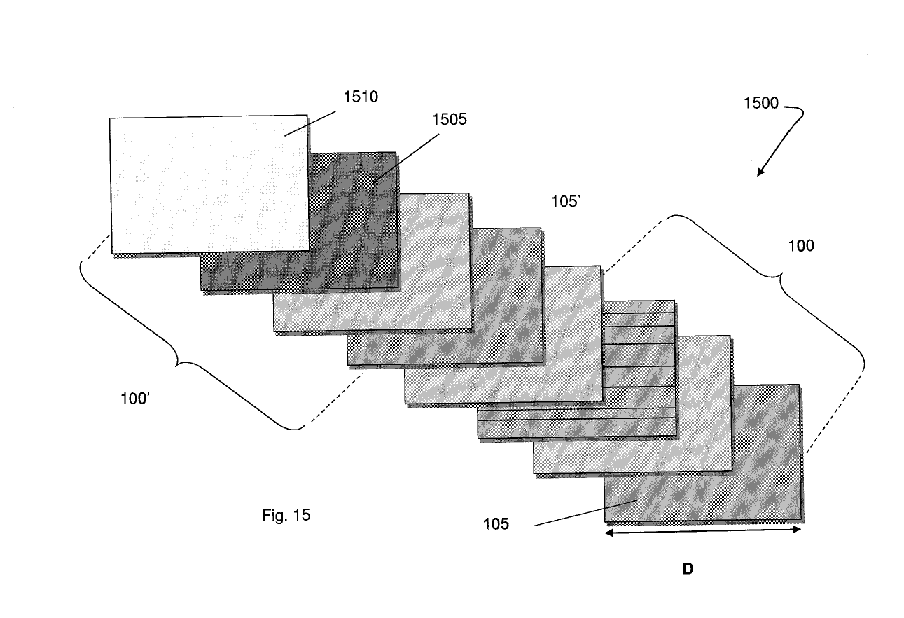

The multi-layered material 1500 depicted in FIG. 15 is similar to the combination of two sets of the multi-layered material 100 depicted in FIG. 1. A difference is one of the filament layers is replaced by a metallic, for example, aluminium, sheet or film 1505. Another difference is the coating layer 1510 which coats the metallic sheet or film is a polymer blend film.

In the above embodiments, the filament layers are shown as having filaments which run in the roll or machine direction, i.e. longitudinal direction, of the material. However, it is possible for a multi-layered material made from the principles of the present invention to include a filament layer where the filaments run in a different direction, ranging between about 5 to 90 degrees from the machine direction. The cross direction is directed at 90 degrees to the machine direction, i.e. transverse to the direction of the roll.

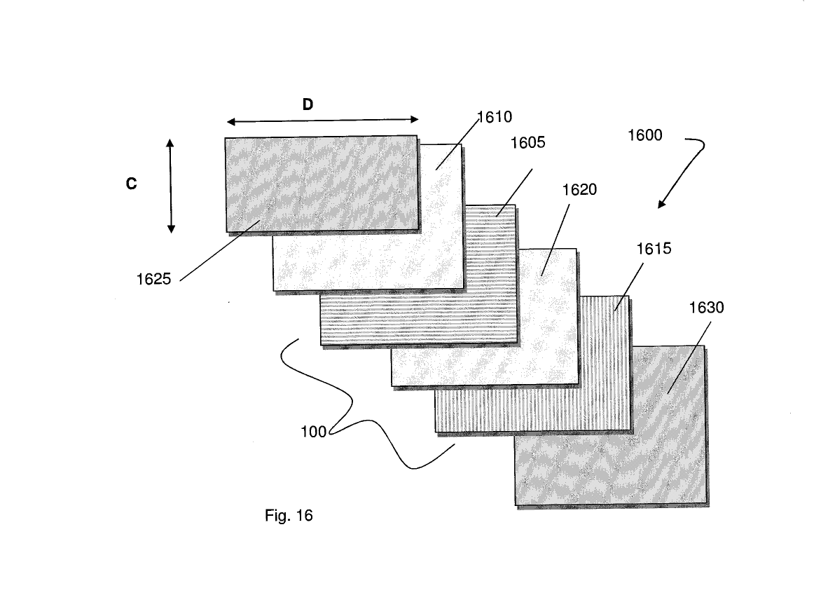

Illustrated in FIG. 16 is another material embodiment, wherein the material 1600 is formed from a layer 1605 of filaments or strands which extend in the roll or machine direction D or longitudinal direction of the material, which is bonded or adhered to a layer 1620 of PP/PE blend coating of approx 40 microns thick. To the reverse side of the layer 1620 is another layer of filaments or strands 1615, which extend in a cross direction C which is at 90 degrees to the roll or machine direction D, and is bonded or adhered to the layer 1620. The angle of 90 degrees is preferred, but any appropriate angle in the range of 5 to 90 degrees to the longitudinal or machine direction can be utilised depending upon what strength result may need to be achieved. If more filament layers are added then these can be at different angles to the first two laid and bonded as desired.

It will be understood that the basic multi-layer material 100, comprised of layers 1605, 160 and 1615 form the basic strength element to which can be added other layers as desired or preferred. In the case of the embodiment of FIG. 16, to the filament layer 1605 is bonded or adhered a layer 1610 of 40 micron PP/PE blend (or from polypropylene, polyethylene, or a polypropylene and polyethylene blend, or another polymer variant), and on the outer side of that, is bonded or adhered a layer 1625 of 105 GSM virgin Kraft paper. Whereas to the layer 1615 is bonded a layer 1630 being a 105 GSM Kraft paper. In the resulting arrangement, the kraft paper outer layer 1625 is located next to the coating layer 1610, preferably with the textured face of the kraft paper layer 1625 facing the coating layer 1610. The positions of the two filament layers 1605, 1615 can be interchanged.

The feature of one non woven strength layer being at an angle to a second non woven strength layer can also be exercised with respect to non-filament layers, i.e. to full width non woven strength layers, in that if such layers have a directional strength characteristic, then the directions of strength can be oriented such that one layer is at an angle to another layer.

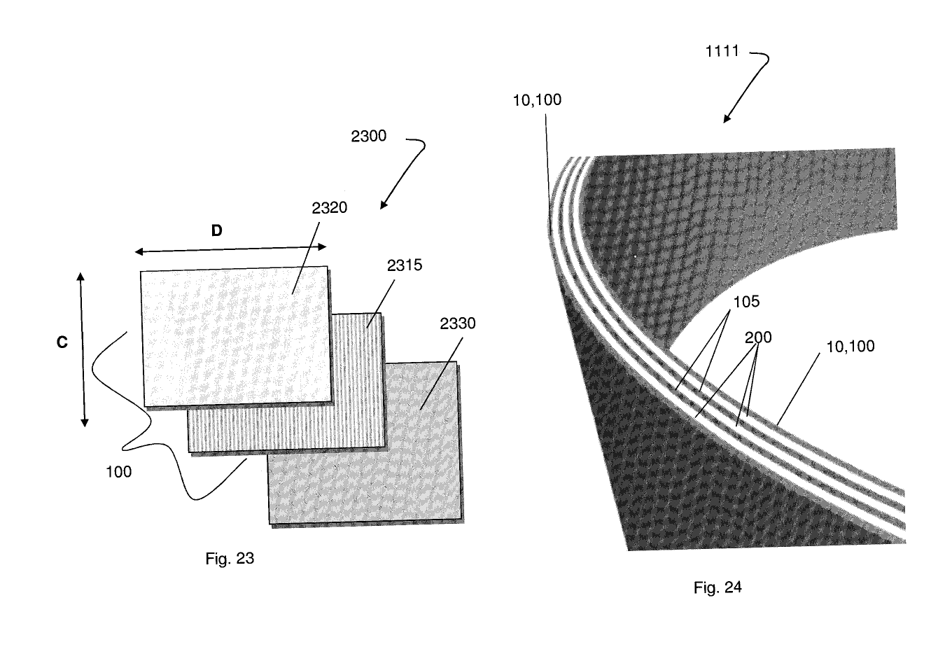

Illustrated in FIG. 23 is another multi-layer material embodiment 2300, wherein the material 2300 is formed from a layer 2315 of filaments or strands which extend perpendicular to the roll or machine direction D or longitudinal direction of the material, that is the cross direction C, which is bonded or adhered to a layer 2320 of PP/PE blend coating of approx 40 microns thick.

It will be understood that the basic multi-layer material 100, comprised of layers 2320 and 2315 which forms the basic strength element to which can be added other layers as desired or preferred. In the case of the embodiment of FIG. 23, to the filament layer 2315 is bonded or adhered a layer 2330 being a 105 GSM Kraft paper.

In the embodiment of FIG. 23, the filament layer 2315 could be replaced by a full width non-woven strength layer which has directional strength characteristics which are aligned to be perpendicular to the roll or machine or longitudinal direction D of the material. Of course it will be understood that another angle between parallel to the direction D and perpendicular to the direction D could be utilised.

Tables 1 to 6 shows test results of stretching and bursting of different samples of the multiple layered structure, to measure the tensile and burst strengths of the materials.

Tables 1 to 3 list the testing results for five samples of a multi-layered structure, having a kraft paper layer of approximately 105 GSM with a 40 to 45 μm polymeric (polypropylene/polyethylene) coating which was heat bonded, and a high tensile polypropylene polymer filament layer, as illustrated in the FIG. 1B.

TABLE 1
Results of tensile testing for material
1, using test method AS 2001.2.3.1

| | | Tensile | | Tensile | |
|---|---|---|---|---|---|
| | | strength | Elongation | strength | Elongation |
| Sample | GSM | (N) - MD | (%) - MD | (N) - CD | (%) - CD |
| 1 | 221.7 | 726.62 | 2.72% | 298.06 | 4.64% |
| 2 | 228.2 | 720.78 | 2.56% | 292.08 | 4.16% |
| 3 | 229.5 | 724.52 | 2.78% | 307.98 | 5.14% |
| 4 | 232.7 | 711.94 | 2.63% | 3.11 | 5.37% |
| 5 | 236.7 | 728.22 | 2.73% | 299.9 | 4.49% |
| average | 229.8 | 722.42 | 2.68% | 240.23 | 4.76% |

MD = Machine (longitudinal) direction.
CD = Cross direction

The samples for the machine direction tensile testing had a gauge length of 200 mm. The samples for the cross direction tensile testing had a gauge length of 100 mm. During the testing recorded in Table 1, the rate of extension used was 20 mm/min. “Elongation” is the maximum percentage of elongation of the sample before the sample ruptured.

TABLE 2
Results of tensile testing for material
1, using test method AS 2001.2.3.2

| | | Tensile | | Tensile | |
|---|---|---|---|---|---|
| | | strength | Elongation | strength | Elongation |
| Sample | GSM | (N) - MD | (%) - MD | (N) - CD | (%) - CD |
| 1 | 221.7 | 634.73 | 3.02% | 336.76 | 5.17% |
| 2 | 228.2 | 661.14 | 3.50% | 321.68 | 5.19% |
| 3 | 229.5 | 643.7 | 3.33% | 372.37 | 5.27% |
| 4 | 232.7 | 651.63 | 3.33% | 328.8 | 5.36% |
| 5 | 236.7 | 652.00 | 3.36% | 341.71 | 5.79% |
| average | 229.8 | 648.64 | 3.31% | 340.26 | 5.36% |

For the tests recorded in Table 2, the samples for both the machine direction tensile and cross direction tensile testing had a gauge length of 100 mm. The rate of extension used was 50 mm/min.

TABLE 3
Results of burst strength testing for material
1, using testing method AS 2001.2.4-1990

| Sample | GSM | Burst strength (KPa) |
|---|---|---|
| 1 | 221.7 | 979.09 |
| 2 | 228.2 | 951.51 |
| 3 | 229.5 | 965.30 |
| 4 | 232.7 | 1103.2 |
| 5 | 236.7 | 1061.83 |
| average | 229.8 | 1012.19 |

Tables 4 to 6 list the testing results for five samples of another multi-layered structure, having an inner layer of high tensile polypropylene polymer filament, and on either side of the polymer a kraft paper outer layer of approximately 105 GSM, as in the FIG. 2 embodiment.

TABLE 4
Results of tensile testing for material
2, using test method AS 2001.2.3.1

| | | Tensile | | Tensile | |
|---|---|---|---|---|---|
| | | strength | Elongation | strength | Elongation |
| Sample | GSM | (N) - MD | (%) - MD | (N) - CD | (%) - CD |
| 1 | 339.0 | 1250.54 | 2.63% | 573.94 | 7.55% |
| 2 | 349.4 | 1337.03 | 3.04% | 567.39 | 7.27% |
| 3 | 333.1 | 1303.56 | 2.87% | 569.53 | 7.43% |
| 4 | 339.0 | 1279.41 | 2.80% | 543.59 | 6.80% |
| 5 | 327.8 | 1311.15 | 3.03% | 517.51 | 6.21% |
| average | 337.7 | 1296.34 | 2.87% | 554.39 | 7.05% |

In the tests recorded in table 4, the samples for the machine direction tensile testing had a gauge length of 200 mm. The samples for the cross direction tensile testing had a gauge length of 100 mm. The rate of extension used was 20 mm/min.

TABLE 5
Results of tensile testing for material
2, using test method AS 2001.2.3.2

| | | Tensile | | Tensile | |
|---|---|---|---|---|---|
| | | strength | Elongation | strength | Elongation |
| Sample | GSM | (N) - MD | (%) - MD | (N) - CD | (%) - CD |
| 1 | 339.0 | 1155.78 | 3.58% | 629.23 | 7.75% |
| 2 | 349.4 | 1229.94 | 3.86% | 607.88 | 7.31% |
| 3 | 333.1 | 1173.25 | 3.94% | 623.3 | 7.75% |
| 4 | 339.0 | 1191.44 | 3.83% | 615.29 | 7.11% |
| 5 | 327.8 | 1185.32 | 3.82% | 602.88 | 6.64% |
| average | 337.7 | 1187.15 | 3.81% | 615.72 | 7.31% |

TABLE 6
Results of burst strength testing for material
2, using testing method AS 2001.2.4-1990

| Sample | GSM | Burst strength (KPa) |
|---|---|---|
| 1 | 339.0 | 1310.05 |
| 2 | 349.4 | 1241.1 |
| 3 | 333.1 | 1172.15 |
| 4 | 339.0 | 1103.21 |
| 5 | 327.8 | 1206.63 |
| average | 337.7 | 1206.63 |

For the tests recorded in Table 5, the samples for both the machine direction tensile and cross direction tensile testing had a gauge length of 100 mm. The rate of extension used was 50 mm/min.

In all of the above embodiments, some or all of the paper layers can be replaced with polymeric layers.

Any two or more of the above embodiments, or variants of the above embodiments, can be bonded together to form further variations.

In the above embodiments, the aluminium sheet/film layers can be replaced with other metallic layers, provided the metal chosen possesses the qualities (e.g. sufficient tensile strength against stretching) for forming sheets or films, to be applied in the situations contemplated herein.

While the above description generally describes a single layer of filaments 110, it will be readily understood that multiple layers of filaments 110 can be utilised. Another advantage of this material is that it is a recyclable material.

In the above embodiments, the coating layers and the polymer blend films can alternatively be food grade coatings and film respectively, or where available, polymeric coatings and film that are food grade. This enables application of the multi-layered materials in food packaging, for domestic or commercial quantities of food stuffs. The food packaging can be in cylindrical or box form.

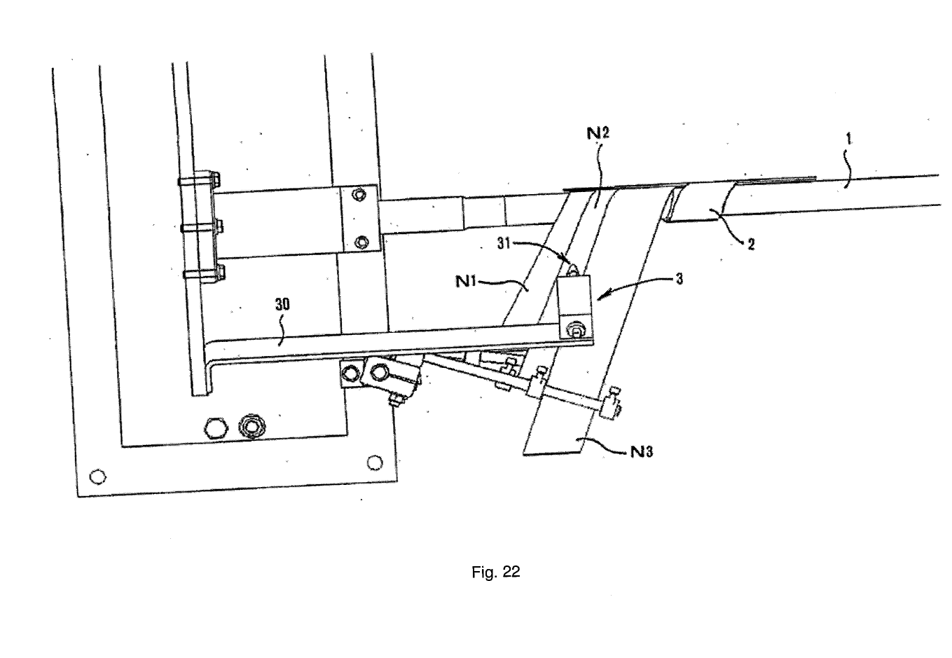

FIG. 22, taken from FIG. 2 of US patent application publication No. 2005255981 to Perini Fabio, partially shows a spiral winding machine, showing strips N1, N2, and N3, being fed into the winding machine, with the strips N1, N2 N3 being wound on a mandrel. The text of US2005255981 is incorporated herein by reference, but it will be understood that any appropriate winding or spiral winding machine or wrapping or similar technology can be used.

In the process of spiral winding the multi-layered materials, there can be different ways of bonding the materials to form the tubing. For instance, lines of glue can be combed across the full width of the material. Variations having cardboard or paper outer layers are suited for this form of bonding.

An alternative way is to use a heat bonding attachment in the spiral winding machine to enable heat bonding across the entire width of the material. Variations of the multi-layered material having polymeric outer layers are suitable for heat bonding. By avoiding for example, a water based glue, and not having paper outer layers, the resulting product is water proof rather than merely water resistant, making the resulting tube suitable for a wider range of applications. For instance waterproof formwork tube can be suitable for use as part of reinforcing piers that are submerged in water, or for forming piers under water. If part of the process, then a wound or spirally wound tube can be placed around an existing pier and grout or similar material can be pumped between the internal surface of the tube and the pier. In such cases a split along the outer circumference of the tube may be needed if it is desired to remove the tube once the grout is set. Also, as the bonding interface does not have porosity, the resulting product may also be useful to be used as sanitary packing products. Nevertheless, heat bonding may also be applied where the multi-layered material includes paper or cardboard outer layers. A further alternative is to employ a combination of gluing and heat bonding. In this case, linear bonding lines, alternating between gluing and heat bonding lines, are arranged.

While the adhesive selected will vary according to application and use of the material, an appropriate glue or adhesive for use with the above described embodiments, and in forming a spiral wound or wound tube, is a one part cross-linking PVA or polyvinyl acetate adhesive, such as that sold under the designation DORUS KL 442.3051, which is D3 water resistant and is manufactured by Henkel.

The above described embodiments are examples only, and are not limiting in the sense of encompassing all possible variations. For example, in any of the above embodiments, or in further embodiments, two or more consecutive non-woven strength layers can be located next to each other. In the case that the two non-woven strength layers both include spaced apart filaments, tapes, ribbons, strips, chords or strands, the individual spaced filaments 110.1, 110.2, 110.3 from the two layers can partially overlap each other, as shown in FIGS. 17 and 18, or completely overlie each other leaving a gap between them, as shown in FIG. 19. Alternatively, the two layers can be arranged such that the filament strips 110.1, 110.2, 110.3 etc. of one layer 110 overlie the spacing between the filament strips 110.1, 110.2, 110.3 etc. of the other layer 110, as shown in FIG. 20, or overlap each other as in FIG. 21. In FIGS. 17 to 21 the kraft paper or polymer layer 15 is also illustrated, and while a space is represented between the layers 110, 110 and 15, such a space will not be present in the assembled material 100 when properly adhered or bonded together.

The above paragraphs describe using spiral winding preferably onto a stationary mandrel, to form the multi-layered material into tubes e.g. for concrete formwork, or a building or constructional element such as part of a pier or column, as it will remain in place. An alternative is to wrap the material around a turning mandrel for parallel wrapping.

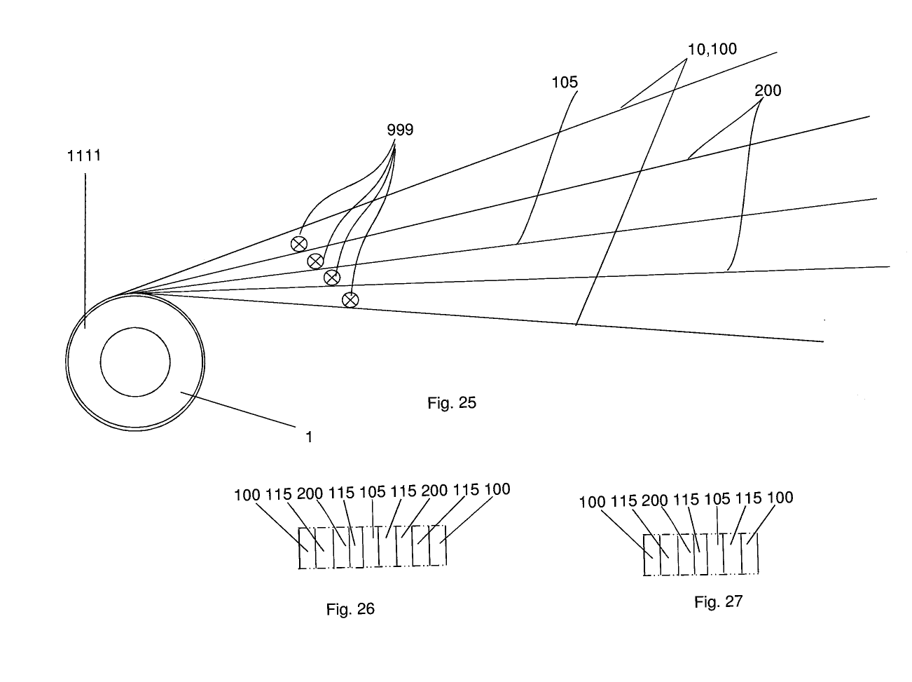

Illustrated in FIG. 24 is a part section through a spiral wound or wound or wrapped concrete formwork tubing or construction element 1111, which is also shown in FIG. 25 as being spirally wound onto a mandrel 1 of FIG. 22. The resultant tubing 1111 has an inner and outer layer of the material 100 (or 10 or both), which is adhered an adjacent layer of material 200, which respectively have their upper and lower sides adhered to a layer of Kraft paper 105. The adhering process is effected by means of adhesive spray or combing stations 999 located between each layer coming together in the tubing 1111, as is illustrated in FIG. 25, so as to deliver into the tubing 1111 an adhesive layer of approx. 40 microns (40 μm). Such spraying or combing can prevent excess glue being applied, or if glue is squeezed out during the winding process, it can be collected or otherwise disposed of, as is known in the art.

The illustration of FIGS. 24, 25 and 26 show the number of layers that might be used in relatively small large concrete formwork tubing, say of the order of 1000 mm to 2400 mm diameters or for a long length of tubing say of the order of 7 metres to 14 metres in length, as hydrostatic pressure will increase with height and thus greater strength is needed.

It will be readily understood by those in the tube winding industry, that multiple layers of the filament sheet materials 10, 100 200 etc. and that depending upon the applications and hydrostatic pressures to be resisted that anything form say 2 to 25 filament layers may be required, depending upon such factors as the MPa of the concrete to be poured, the setting time thereof, the diameter and the length of the tube 1111 to be used.

For tubular formwork of lesser diameter, say 200 mm to 950 mm, as can be seen in FIG. 27, one of the adhesive layers 115 and one layer of material 200, can be removed as the burst strength required for smaller diameters or shorter lengths, is much less than larger diameters, as the hydrostatic pressures applied by concrete poured into the mould is commensurately less. In Australian concrete pouring standards, when pouring of concrete columns is occurring, standards require that no more than 3 metres of concrete is poured, before the previous three metres has set.

As is illustrated in FIGS. 24 to 27, a spiral wound formwork or building element tube 1111 has multiple layers, which having at least two layers comprised of a multi-layered sheet material such 10, 100, 200, 300, 400 etc. as described above, with each of the multi-layered sheet material 10, 100, 200, 300, 400 etc. including at least one non-woven filament layer 110 that includes a plurality of reinforcing filaments 110.1, 110.2, 110.3, 110.4 etc., each of the multi-layered sheet material 10, 100, 200, 300, 400 etc. also including the non-woven filament layer 110 being bonded or adhered to at least one layer of paper, cardboard or polymer 15 or 105 etc. as described above with the multiple layers also including at least one layer of paper, cardboard or polymer 105 between said at least two multi-layered sheet materials 10, 100, 200, 300, 400 etc. as illustrated in FIGS. 26 and 27. Each multi-layered sheet material 10, 100, 200, 300, 400 etc. has at least one non-woven filament layer 110 or its equivalent as illustrated in other figures. An adhesive layer 115 can be used to bond the multiple layers together into the tube 1111, or heat bonding can be used to bond the multiple layers together into said tube 1111. If desired there can be four layers of the multi-layered sheet material 100, and 200, and at a location intermediate an inner and outer layer is located at least one layer of paper, cardboard or polymer 105, each layer being bonded by an adhesive layer 115; or there can be three layers of said multi-layered sheet material 100, and 200, and at a location intermediate an inner and outer layer is located at least one layer of paper, cardboard or polymer 105, each layer being bonded by heat bonding.

The tube 1111 can include at least one layer which is a hydrophobic layer such or a waterproofing layer as layer 120 from FIG. 1B. The at least one layer of the hydrophobic layer or a waterproofing layer 120 can be located at one or more than one of the following locations: an innermost layer of said tube, an outermost layer of said tube; an intermediate layer of said tube.

The filaments 110.1, 110.2, 110.3, 110.4 etc. can extend in one of the following directions: in the general longitudinal direction of said multi-layered sheet material as is seen in FIGS. 1B and 2; at an angle to the general longitudinal direction of said multi-layered sheet material as is represented by the layers 1605 ad 1615 of FIG. 16; or at an angle in the range of 5 to 90 degrees to the general longitudinal direction of said multi-layered sheet material.

The filaments 110.1, 110.2, 110.3, 110.4, etc. can be one or more of the following: strips; straps; strands; tapes; the filaments are spaced from each other in said non-woven filament layer; polymeric; fibreglass; metal wire filaments; polypropylene; polyethylene; a polypropylene and polyethylene blend; polyester; or a blend of polymers.

When assembled in the tube 1111, a first non-woven filament layer such as layer 1605 has its directional strength characteristics at an angle to a second non-woven filament layer 1615.

In the above description, reference is made to filaments, and it will be readily understood that the word filament encompasses filaments of both monofilament and multifilament types.

An advantage of a non-woven filament layer in a wrapped, wound or spirally wound tube formwork or construction element, is that it leads to a reduction of cost of manufacturing, with a greater strength characteristic by comparison with a similar number of layers of prior art tubular form work such as that described in Australian patent 2004613313, wherein a tube having woven polymer mesh is described. Such reduction in cost also comes from less weight of material, as the cross woven threads of a woven polymer mesh are not present.

The advantages of the non-woven filament layer, being a combination of layers 20 and 15, or layers 25 and 20 in FIG. 1, or say layers 110 and 120, or layers 110 and 105 with an intervening adhesive layer 115, are believed to be derived by the way in which the filaments 110.1 to 110.5 etc. in layer 20, firstly bond to a first layer such as layer 15 or 25 as illustrated in FIG. 1C, but additionally, when a second layer such as layer 25 or 15 is also bonded thereto, because there is spacing between adjacent tapes say 110.5 and 110.4, the centres of the spaces being represented by vertical axes 16 in FIG. 1C, the upper layer 25 will bond directly in the spacings which have centres 16, forming a series of lines of bonding (into the page of FIG. 1C) between the upper layer 25 and the lower layer 15 spaced across the width of the material, as well as to the upper surfaces of the filaments 110.1 to 110.5 etc., which filaments all extend in the same general direction. This gives the sheet materials 10, 100 200 etc. an advantage over the woven polymer mesh of Australian patent 2004613313, which will provide a series of spot or point contacts or bonding between upper and lower layers either side of the mesh, due to the warp and weft nature of the woven material, rather than lines of contact and bonding as in the embodiment's of the present invention.

Another advantage derives from the machine direction or alignment of the direction of the filament with the sheet material roll which directly creates the strength properties while the presence of cross direction woven filaments of the prior art has no functional purpose and creates a barrier to bonding. Such a woven formation creates an un-level or uneven material with elongation properties that can affect structural integrity of the formed product. Level or even filaments as described in the embodiments herein, together with bonding, creates a tube such that helical stability minimises unnecessary elongation and optimising strength together with a reduction of weight and material, by comparison to prior art systems.

The illustration of FIG. 1C shows the overlaying of layers 15, 20 and 25, which may be heat bonded without intervening adhesive layers. Otherwise between these layers an adhesive layer can be located, as would be the case if the layer 120 of FIG. 1B replaced the layer 25, and layer 110 replaced the layer 20, and layer 105 replaced the layer 15, in which case adhesive layer 115 would intervene between layer 110 and 105, however, the same mechanism of line bonding to the filaments and the adjacent layers, and the line bonding of upper 120 to lower layer 105, on opposite side of the filaments, will occur.

In manufacturing spirally or other wound type tubing of various heights or lengths, and of various diameters, the numbers of layers of non-woven filament layered sheet material 10, 100, 200 etc. can be readily established by trial and error and calculation. The numbers of layers of non-woven filament layered sheet material 10, 100, 200 etc. and the finished thickness of the tubular formwork or construction element will also be dependent upon the MPa value of the concrete and its settling time. All these factors affect the hydrostatic burst pressure resistance that must be provided by the tube, as will be readily understood in the formwork and winding arts.

While the above description focuses on spiral winding, that is a helical winding, it will be readily understood that the tubular formwork or construction element can be made by straight or cylindrical winding, or other winding or wrapping techniques.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A construction element tube having multiple layers which include at least two layers comprised of a multi-layered sheet material,
each of said multi-layered sheet material including at least one non-woven filament layer that includes a plurality of reinforcing filaments, each of said multi-layered sheet material also including said non-woven filament layer being bonded or adhered to at least one layer of paper, cardboard or polymer.

2. A construction element tube as claimed in claim 1 wherein said multiple layers also include at least one layer of paper, cardboard or polymer between said at least two multi-layered sheet materials.

3. A construction element tube as claimed in claim 1, wherein said multi-layered sheet material each has a multiple number of non-woven filament layers.

4. A construction element tube as claimed in claim 1, wherein said tube is formed by one or more than one of the following means: an adhesive is used to bond said multiple layers together into said tube; a heat bonding process is used to bond said multiple layers together into said tube; said multiple layers are spirally wound; said multiple layers are cylindrically or straight wound; said multiple layers are wrapped.

5. A construction element tube as claimed in claim 1, wherein there are at least three layers of said multi-layered sheet material, and at a location intermediate an inner and outer layer of said multi-layered sheet material is located said at least one layer of paper, cardboard or polymer, each layer being bonded by an adhesive layer.

6. A construction element tube as claimed in claim 1, wherein said tube includes at least one layer which is a hydrophobic layer or a waterproofing layer.

7. A construction element tube as claimed in claim 6, wherein at least one layer of said hydrophobic layer or a waterproofing layer is located at one or more than one of the following: an innermost layer of said tube, an outermost layer of said tube; an intermediate layer of said tube.

8. A construction element tube as claimed in claim 1, wherein said filaments extending in one of the following directions: in the general longitudinal direction of said multi-layered sheet material; at an angle to the general longitudinal direction of said multi-layered sheet material; if more than one then a first in the general longitudinal direction and another at an angle in the range of 5 to 90 degrees to the general longitudinal direction of said multi-layered sheet material.

9. A construction element tube as claimed in claim 1, wherein said filaments are one or more of the following: strips; ribbons, straps; strands; tapes; said filaments are spaced from each other in said non-woven filament layer; polymeric; fibreglass; metal wire filaments; polypropylene; polyethylene; a polypropylene and polyethylene blend; polyester; or a blend of polymers.

10. A construction element tube as claimed in claim 1, wherein when assembled in said tube, a first non-woven filament layer has its directional strength characteristics at an angle to a second non-woven filament layer.

11. A multi-layered material, including at least one non-woven strength layer, and a layer of paper, cardboard or polymer, the layers being bonded together.

12. A multi-layered material as claimed in claim 11, wherein the non-woven strength layer is a full width strength layer or is a filament layer that includes a plurality of strips, straps, strands, or tapes in the form of filaments.

13. A multi-layered material as claimed in claim 11, wherein the non-woven strength layer is a combination of full width and filament layers.

14. A multi-layered material as claimed in claim 12, wherein the filament layer includes one or more than one of the following:
filaments which run in a longitudinal direction of the multi-layered material, or in a direction that is at about a 5 to 90 degree angle to the longitudinal direction;
a polymeric material, said polymeric material being polypropylene, polyethylene, a polypropylene and polyethylene blend, or polyester; the filament layer can include a plurality of strips, straps, strands, or tapes of filaments, the strips or tapes being spaced from each other; when multiple layers of filament are present in the filament layers, adjacent filament layers can overlap or overlie each other; the strips or tapes of filaments from one non-woven strength layer overlie spacing between filament strips or tapes of the other non-woven strength layer; filaments in the non-woven strength layer are polymeric, fibreglass, or metal wire filaments, or combinations of these; filaments which are multi-strand filaments; filaments which run in a roll direction of the layer or multi-layers.

15. A multi-layered material as claimed in claim 12, including at least two non-woven strength layers being one of: a full width strength layer and a layer of filaments; two full width strength layers; or two layers of filaments

16.-20. (canceled)

21. A multi-layered material as claimed in claim 11, wherein the layer of paper, cardboard or polymer is paper, and weighs 20 grams per square metre or more.

22. A multi-layered material as claimed in claim 11, further including one or more than one of the following: a coating on either or both of the non-woven strength layer and layer of paper, cardboard or polymer; a food grade coating on either or both of the non-woven strength layer and layer of paper, cardboard or polymer.

23. (canceled)

24. A multi-layered material as claimed in claim 11, further including another paper layer that is bonded to the layer of paper, cardboard or polymer, the layer or paper, cardboard or polymer and the other paper layer being bonded together by a waterproof adhesive film or a food grade water proof adhesive film.

25. (canceled)

26. A multi-layered material as claimed in claim 11, having one or more than one of the following: two or more non-woven strength layers, there being at least one layer of paper, cardboard, or polymer, or a coating layer, between each adjacent two of the two or more non-woven strength layers; an adhesive film as an outer layer; one or both outer layers are paper or a polymeric material.

27.-30. (canceled)

31. A multi-layered material as claimed in claim 11, wherein one or more than one of the following are included: a second non-woven strength layer is adhered or bonded in said material so that a directional strength characteristic of said second non-woven strength layer is at an angle to a directional strength characteristic of a first non-woven strength layer;
a second filament layer is adhered or bonded in said material so that a directional strength characteristic of said second filament layer is at an angle to a directional strength characteristic of a first filament layer;
a layer of cardboard, paper or polymer is located between a first and second non-woven strength layer; a first non-woven strength layer is located between a layer of cardboard, paper or polymer and a second non-woven strength layer.

32.-34. (canceled)

35. A multi-layered material as claimed in claim 31, wherein said second layer has its directional strength characteristics at an angle of between 5 and 90 degrees to said first layer.

36. A multi-layered material as claimed in claim 15, wherein a first of said non-woven strength layers is arranged in said material so that a directional strength characteristic of said first layer, is parallel to the roll or machine or longitudinal direction of said material, and said second layer has its directional strength characteristic an angle thereto.

37. A multi-layered material as claimed in claim 11, wherein there is only one non-woven strength layer and that layer has a directional strength characteristic, or filaments or straps thereof, which is or are aligned in a manner which is one of the following: generally parallel to the roll or machine or longitudinal direction of said material; generally lateral to the roll or machine or longitudinal direction of said material, i.e. a cross direction; at an angle other that of parallel to or at 90 degrees to the roll or machine or longitudinal direction of said material.

38. A tube formed from winding a multi-layered material as claimed in claim 11.

39. A tube as claimed in claim 38, wherein said tube is one or more than one of the following: formed from multiple layers of said multi-layered material which are bonded or adhered either side of a paper layer; manufactured from a winding or spiral winding technique; a concrete formwork tube.

40.-41. (canceled)

42. A formwork having multiple layers which include at least two layers comprised of a multi-layered sheet material,
each of said multi-layered sheet material including at least one non-woven filament layer that includes a plurality of reinforcing filaments, each of said multi-layered sheet material also including said non-woven filament layer being bonded or adhered to at least one layer of paper, cardboard or polymer.
